(19) United States
(12) Patent Application Publication
(10) Pub. No.: US 2008/0162296 A1
(43) Pub. Date: Jul. 3, 2008

(54) REPEAT TRANSACTION RATING

(75) Inventors: Amjad Hanif, Santa Clara, CA (US); Brian Burke, San Jose, CA (US); Jerry T. Chong, San Jose, CA (US); Dan L. Pritchett, San Jose, CA (US); Marc Delingat, Mountain View, CA (US); Snezana Sahter, San Jose, CA (US)

Correspondence Address: SCHWEGMAN, LUNDBERG & WOESSNER, P.A., P.O. BOX 2938, MINNEAPOLIS, MN, 55402, US

(73) Assignee: eBay Inc.

(21) Appl. No.: 11/618,690

(22) Filed: Dec. 29, 2006

(51) Int. Cl. G06Q 30/00; G06Q 90/00

(52) U.S. Cl. 705/26

(57) ABSTRACT

Embodiments of configuring elements of a server of a product or server sales architecture in mechanisms are described generally herein including a server that may enable a seller to specify information about an item offered for purchase or bid and may display information to potential buyers about the item along with an indication of a repeat transaction rating for the seller based on transactions conducted by the server for the seller. Other embodiments may be described and claimed.

### TECHNICAL FIELD

Various embodiments described herein relate generally to publication systems (PS), including apparatus, systems, and methods used in product or service related publication systems.

### BACKGROUND INFORMATION

An publication system may act as an interface between one or more sellers offering goods or services for purchase or bid. A seller may provide product or service information, pricing information, and contact information to a publication system. The publication system may generate an electronic representation of the sellers' product or service offering where a buyer may be able to view the representations via an electronic interface or buyer system.

### BRIEF DESCRIPTION OF THE DRAWINGS

FIG. 1 is a block diagram of product or service publication system architecture according to various embodiments.

FIG. 2 is a diagram of communication between a buyer system and a publication system in a product or service publication system architecture according to various embodiments.

FIG. 3 is a system diagram of an electronic product or service publication system architecture according to various embodiments.

FIG. 4 illustrates a computer system in which an browser application resides that may display publication system generated content according to various embodiments.

FIG. 5 illustrates a computer system in which an browser application resides that may display publication system generated content according to various embodiments.

FIG. 6 illustrates repeat rating content that may be included in a browser display according to various embodiments.

FIG. 7 is a flow diagram illustrating several methods according to various embodiments.

FIG. 8 is a block diagram of an article according to various embodiments.

FIG. 9 is a block diagram of an article according to various embodiments.

### DETAILED DESCRIPTION

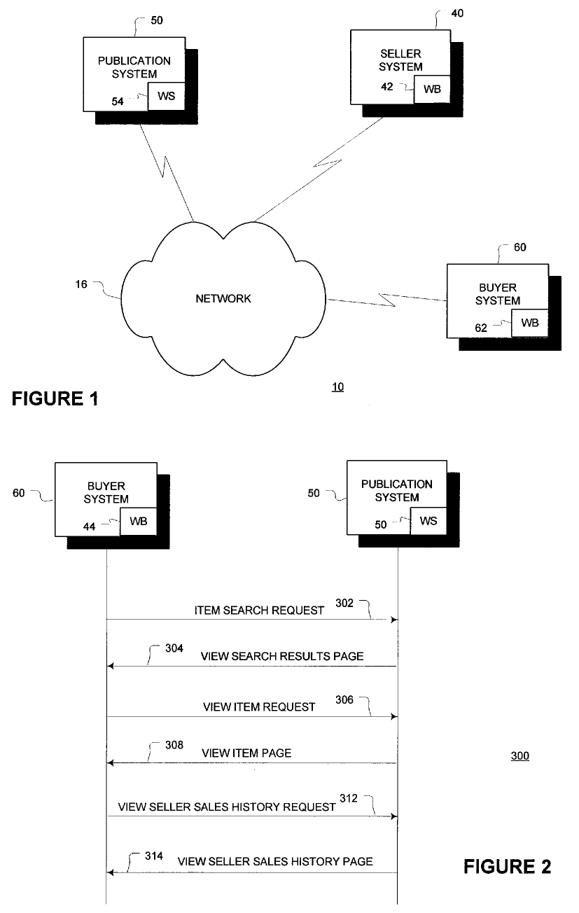

FIG. 1 is a block diagram of a product or service publication system architecture 10 comprising a buyer system 60, a publication system 50, and a seller system 40 according to various embodiments. The buyer system 60 may communicate with the publication system 50 via a network 16 where the network may be a local wired or wireless network or a network of networks such as the Internet. The seller system 40 may also communicate with the publication system 50 via the network 16. In an embodiment the seller system 40 may be part of the publication system 50. In order to expedite sales or inspire conference in a seller, a publication system 50 may enable a potential buyer to view an indication of a seller sales or transaction history.

In an embodiment the publication system 50 includes a web-server 54 where the web-server 54 may be configured to communicate messages and content with the buyer system 60. The web-server 54 may also be configured to communicate messages and content with the seller system 40. The seller system 40 may host a web browser application 42 such as Internet Explorer, Safari, Netscape, Firefox, or Opera 34 that may be configured to communicate messages and content with the publication system 50. In an embodiment, a buyer system 60 may also host a web browser application 42 such as Internet Explorer, Safari, Netscape, Firefox, or Opera 34 that may be configured to communicate messages and content with the publication system 50. In an embodiment the seller system 40 or buyer system 60 may be any computer device capable of hosting an interface that can communicate with the publication system 50 including a web browser application 42, 62 including a personal computer, personal data assistant, or web enabled cellular phone.

FIG. 2 is a diagram of communications 300 between an publication system 50 and a buyer system 60 according to various embodiments. In an embodiment the publication system 50 may provide information about products or services for sale or bid by one or more sellers. The publication system 50 may also provide information about a seller including one or more indications of transactions conducted by the publication system 50 for a seller and transaction ratings by associated buyers. A buyer via a buyer system 60 may view or search an electronic catalog or item listing(s) and purchase, offer to purchase, or bid on one or more product or service items shown in the electronic catalog or listing(s).

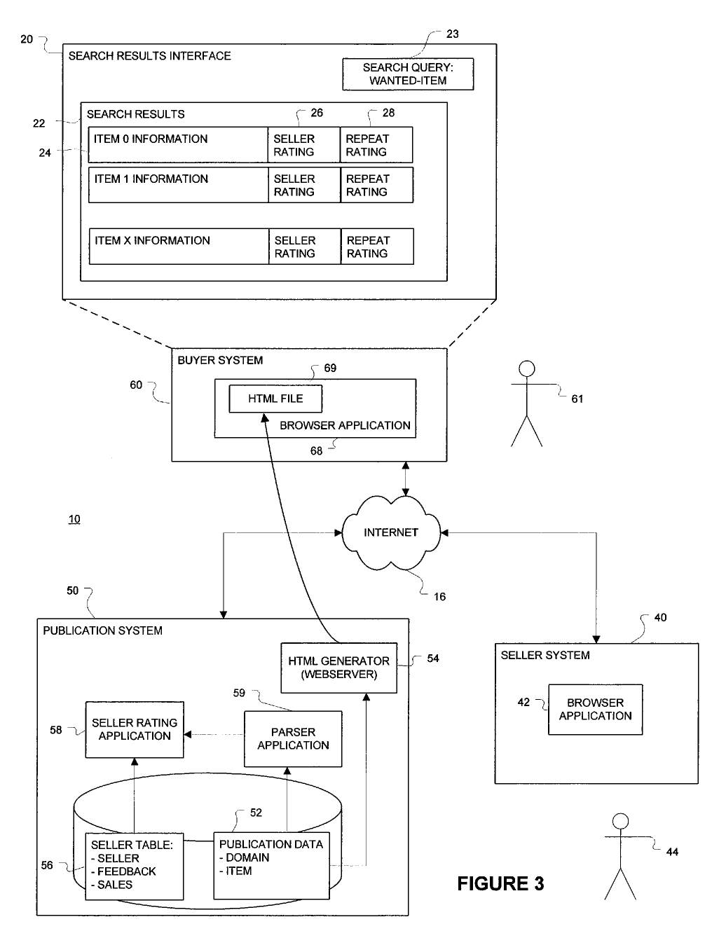

In an embodiment a buyer via a buyer system 60 web browser 62 may generate or populate a product or service item search request 302 that is processed by the publication system 50 web-server 54. The publication system 50 may search a product or service item database (52 in FIG. 3) to locate items based on the search request 302 and generate a view search results page 304 (such as the search results interface 20 shown in FIG. 3). The search results 22 may include items correlated to the search criteria 23. Each item 24 may also include information about the corresponding seller. The seller information may include a seller rating 26 and a seller repeat transaction rating 28. The seller rating 26 may be determined as a function of feedback provided by parties for transactions conducted by the publication system 50 for the seller.

The repeat transaction rating 28 may include a user perceptible indication such as a numerical value or graphical icon(s) that vary as a function of the number of transactions conducted by the publication system 50 for the seller and the number of buyers associated with the transactions. The repeat transaction rating may also vary as a function of the transactions value, related buyer rating, the transaction rating, and the item 24 categorization.

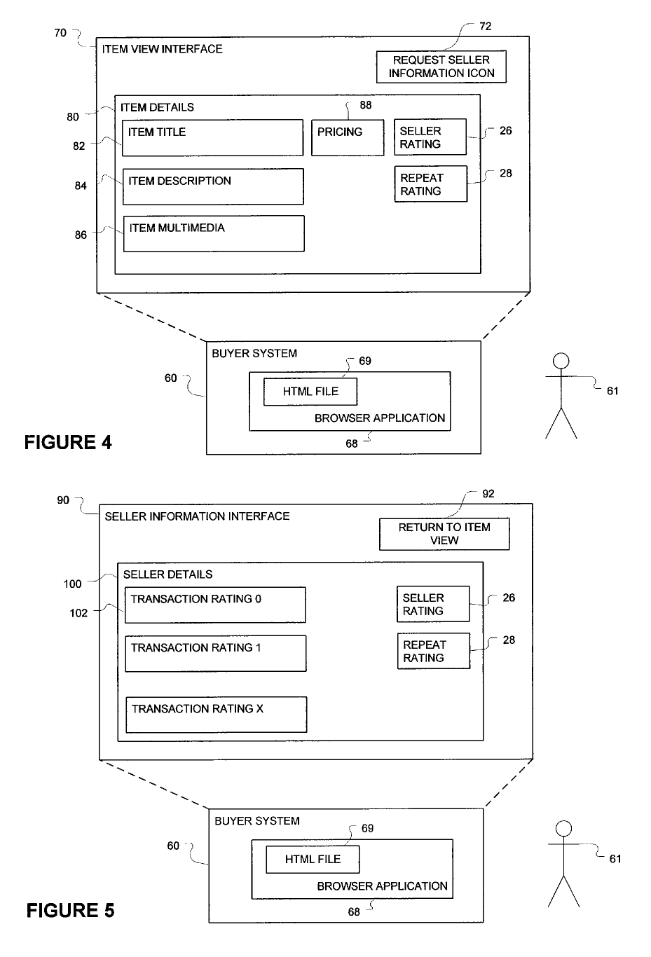

A user via a web browser 62 may then select one of the items 24 for further review where the web browser 62 may generate a view item request 306. The publication system 50 web-server 54 may receive the view item request 306 and generate a view item page 308 that is forwarded to the user web browser 62. The view item page 308 may include information about the item such as the title, description, pricing, multimedia (such as shown in FIG. 4). The view item page 308 information may also include corresponding seller information. The seller information may include a seller rating and a seller repeat transaction rating.

In an embodiment a buyer via the buyer system 60 may request additional information about an item's seller via a view seller sales and history request 312. In response the publication system 50 may generate a view seller sales history page 314. The view seller sales history page 314 may include details about one or more transactions and a seller rating and a seller repeat transaction rating.

FIG. 3 is a system diagram of an electronic product or service publication system architecture 10 including the buyer computer system 60, the publication system 50, and a seller computer system 40 coupled to a network 16 (e.g., the Internet). A buyer 61 may use the computer system 60 to search for items representing products or services available from one or more sellers via a publication system 50. A seller 44 may use a computer system 40 to place one or more items for sale or bid via the publication system 50. The computer system 40 and 60 may include an interface to communicate with a server 54 on the publication system 50. In an embodiment the interface may include a browser application 42, 68 that resides on the computer system 40, 60 and the server 54 may be a web-server 54 that generates browser displayable content such as hyper text markup language (HTML).

The publication system 50 may include the web-server 54, parser application 59, seller rating application 58 and a seller table 56 and a publication data table 52 in a database. The seller table 56 may store information about the seller, reviews or feedback provided by one or more users for transactions conducted by the publication system 50 for the seller, and transaction history information. The publication data table 52 may include domain information and item information. The domain information may include indexes for the seller table and item information and related publication data. The item information may include information about items that have been placed for sale or bid on the publication system include item descriptions, pricing, and multimedia including video, audio, and image content.

The parser application 59 may process search requests, item view requests, buyer information requests, and sellers history or information requests. The parser application 59 may retrieve and assemble content or data from the tables 52, 56 in response to publication information data requests. The seller rating application 58 may determine seller ratings including transactional ratings and repeat transactional ratings periodically or on demand including in response to a publication data request that includes one or more items listed or placed on the publication system 50 via the seller.

In FIG. 3 a buyer 61 via a computer system 60 may submit a search request for a “wanted-item” via the browser application 68. The publication system 50 parser application 59 may search the item database or table 52 and indexes to located items correlated to the search request. The seller rating application 58 may determine one or more seller rating indicators based on data stored in the seller table 58. The web-server 54 may populate an HTML file 69 with search result data and seller rating data provided by the seller rating application 58 and parser application 59. The web-server 54 may forward the HTML file 69 to the buyer computer system 60 via the network 16. The browser application 68 may generate the search result interface 20 in a user perceptible format.

The search result interface 20 may include search query information 23 and a search result section 22. The search query information may include the search terms that were processed by the publication system 50. The search results section 22 may include item information for 0 to X located items and associated seller rating 26 and repeat transaction rating 28 indicators. The seller rating 26 may represent a compilation of feedback provided by one or more users for publication system 50 transactions in which the seller participated. The repeat transaction rating 28 indicator may represent a correlation of buyers, buyer's rating, transaction values, transaction category, and transactions conducted by the publication system 50 for the seller.

In an embodiment the item 24 field, seller rating 26 field, or repeat rating 28 field may include a hypertext link to the publication system 50 web-server 54. Upon selection of an item 24 field the publication system 50 via the parser application 59, seller rating application 58, and web-server 54 may generate a view item page. Upon selection of the seller rating 26 or repeat rating 28 field the publication system 50 via the parser application 59, seller rating application 58, and web-server 54 may generate a view seller sales history page. The computer system 60 browser application 68 may generate the item view interface 70 shown in FIG. 4 upon receipt of the view item page HTML content from the web-server 54. The item view interface 70 may include an item detail section 80 and a request seller information icon 72. The item detail section 80 may include an item title 82, item description 84, item multimedia 86, item pricing 88, seller rating 26, and repeat transaction rating 28 information or content. The seller rating 26 field or repeat rating 28 field may include a hypertext link to the publication system 50 web-server 54. Upon selection of the seller rating 26 or repeat rating 28 field the publication system 50 via the parser application 59, seller rating application 58, and web-server 54 may generate a view seller sales history page.

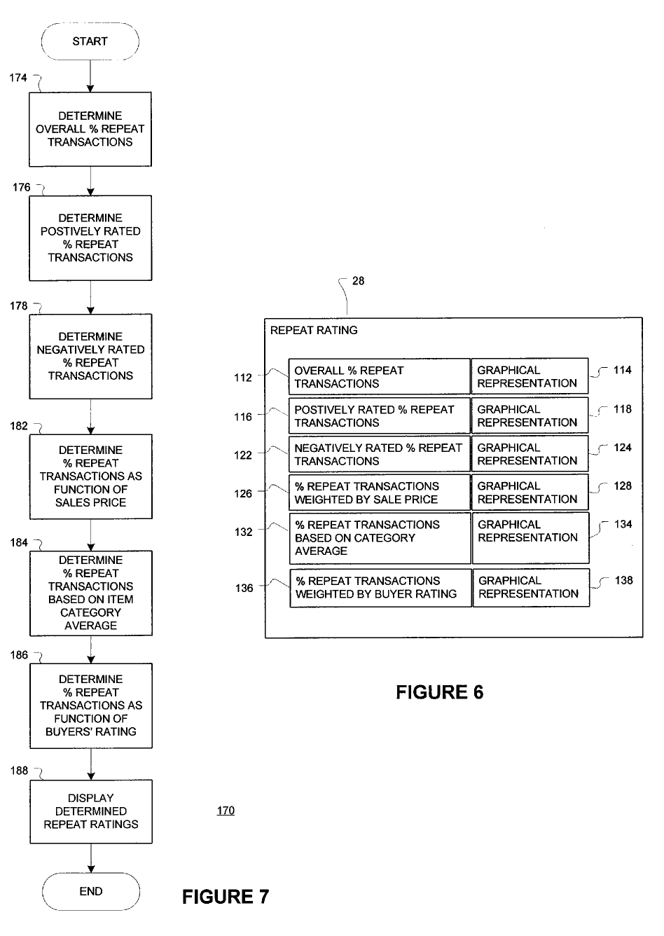

The computer system 60 browser application 68 may generate the seller information interface 90 shown in FIG. 5 upon receipt of the view seller sales history page HTML content from the web-server 54. The seller information interface 90 may include a seller details section 100 and a return to item view icon or section 92. The seller detail section 100 may include transaction ratings 0 to X 102, the seller rating section 26, and the repeat transaction rating section 28. As shown in FIG. 6 the repeat transaction rating section 28 may include an overall percentage of repeat transactions field 112, a graphical representation 114 of field 112, a positively rated percentage of repeat transactions field 116, a graphical representation 118 of field 116, a negatively rated percentage of repeat transactions field 122, a graphical representation 124 of field 122, a percentage of repeat transactions weighted by sale price field 126, a graphical representation 128 of field 126, a percentage of repeat transactions based on item categorization field 132, a graphical representation 134 of field 132, a percentage of repeat transactions weighted by buyer rating field 136, and a graphical representation 138 of field 136.

FIG. 7 is a flow diagram of a repeat transaction determination method 170 according to various embodiments. In the method 170 the publication system 50 via the parser application 59, seller rating application 58, and tables 52, 56 may determine the number of sales transactions conducted by the publication system for the seller (total-sales-trans). The system 50 may also determine the number of unique buyers for sales transactions conducted by the publication system for the seller (total-unique-buyers). Based on total-sales-trans and total-unique-buyers the method 170 may determine the value of the overall percentage of repeat transactions field 112 (activity 174). The method 170 may also generate a graphical representation 114 of the determined field 112. The graphical representation 114 may enable a user to determine the approximate value of the field 112.

In an embodiment a user of the publication system 50 may rate a transaction completed on the system 50. The user may rate the transaction 50 positively, negatively, or neutrally. In the method 170 the publication system 50 via the parser application 59, seller rating application 58, and tables 52, 56 may determine the number of sales transactions conducted by the publication system for the seller that a buyer rated positively (total-positive-sales-trans). The system 50 may also determine the number of unique buyers for the determined buyer rated positively sales transactions conducted by the publication system for the seller (total-positive-sales-unique-buyers). Based on total-positive-sales-trans and total-positive-sales-unique-buyers the method 170 may determine the value of the percentage of repeat positively rated transactions field 116 (activity 176). The method 170 may also generate a graphical representation 118 of the determined field 116.

In the method 170 the publication system 50 via the parser application 59, seller rating application 58, and tables 52, 56 may determine the number of sales transactions conducted by the publication system for the seller that a buyer rated negatively (total-negative-sales-trans). The system 50 may also determine the number of unique buyers for the determined buyer rated negatively sales transactions conducted by the publication system for the seller (total-negative-sales-unique-buyers). Based on total-negative-sales-trans and total-negative-sales-unique-buyers the method 170 may determine the value of the percentage of repeat negatively rated transactions field 122 (activity 178). The method 170 may also generate a graphical representation 124 of the determined field 122.

In the method 170 the publication system 50 via the parser application 59, seller rating application 58, and tables 52, 56 may determine the number of sales transactions conducted by the publication system for the seller (total-sales-trans). The system 50 may determine the number of unique buyers for sales transactions conducted by the publication system for the seller (total-unique-buyers). The system 50 may also determine the sales price of the each transaction (sales-price-trans). Based on total-sales-trans, total-unique-buyers, and sales-price-trans, the method 170 may determine the value of the percentage of repeat transactions weighted by sale price field 126 (activity 182). The system 50 may also generate a graphical representation 128 of the determined field 126.

In an embodiment a user of the publication system 50 may categorize items and the corresponding transactions. In the method 170 the publication system 50 via the parser application 59, seller rating application 58, and tables 52, 56 may determine the number of sales transactions in the item category via the publication system (total-category-sales-trans). Based on total-sales-trans, total-unique-buyers, and category-sales-trans, the system 50 may determine the value of the percentage of repeat transactions based on category average field 132 (activity 184). The system 50 may also generate a graphical representation 134 of the determined field 132.

In an embodiment a seller of the publication system 50 may rate buyers that participate in a transaction completed on the system 50. In the method 170 the publication system 50 via the parser application 59, seller rating application 58, and tables 52, 56 may determine the buyer rating for sales transactions conducted by a seller (buyer-rating-trans). Based on total-sales-trans, total-unique-buyers, and buyer-rating-trans, the method 170 may determine the value of the percentage of repeat transactions weighted by buyer rating field 136 (activity 186). The system 50 may also generate a graphical representation 138 of the determined field 136.

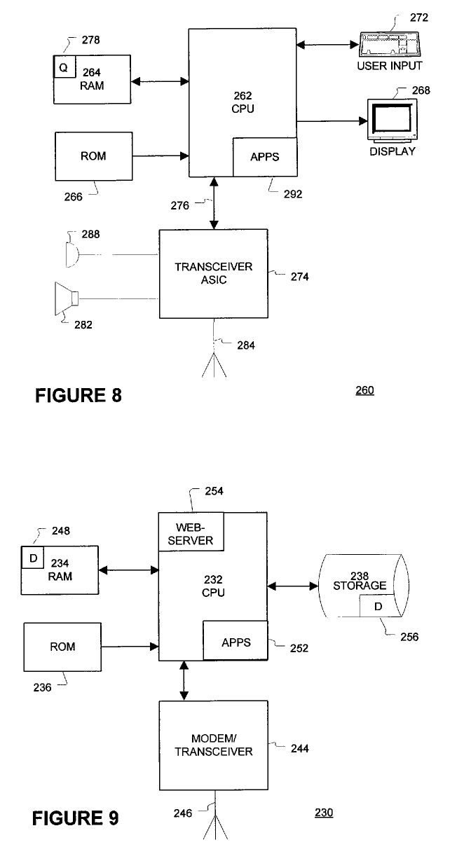

A device 260 is shown in FIG. 8 that may be used in various embodiments as a buyer system 60 or seller system 40. The device 60 may include a central processing unit (CPU) 262, a random access memory (RAM) 264, a read only memory (ROM”) 266, a display 268, a user input device 272, a transceiver application specific integrated circuit (ASIC) 274, a microphone 288, a speaker 282, and an antenna 284. The CPU 262 may include an application module 292 including a browser application module. The RAM 264 may include a queue 278 where the queue 278 may store publication system 50 content. In an embodiment the applications 292 may be a separate element. The application module 292 may process messages or pages from and generate messages or pages for the publication system 50 web-server 54.

The ROM 266 is coupled to the CPU 262 and may store the program instructions to be executed by the CPU 262, and application module 292. The RAM 264 is coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear received messages or pages from the publication system 50 web-server 54.

The microphone 288 and speaker 282 may be incorporated into the device 260. The microphone 288 and speaker 282 may also be separated from the device 260. Received data may be transmitted to the CPU 262 via a serial bus 276 where the data may include messages or pages received, messages or pages to be transmitted, or protocol information. The transceiver ASIC 274 may include an instruction set necessary to communicate messages or pages in architecture 10. The ASIC 274 may be coupled to the antenna 284 to communicate wireless messages or pages within the architecture 10. When a message is received by the transceiver ASIC 274, its corresponding data may be transferred to the CPU 262 via the bus 276. The data can include wireless protocol, overhead information, and pages to be processed by the device 260 in accordance with the methods described herein.

FIG. 9 illustrates a block diagram of a device 230 that may be employed as an publication system 50 in various embodiments. The device 230 may include a CPU 232, a RAM 234, a ROM 236, a storage unit 238, a modem/transceiver 244, and an antenna 246. The CPU 232 may include a web-server 254 and application module 252. The RAM 234 may include a queue or database 248 where the queue 248 may be used to store buyer or seller information including general information, transaction ratings, sales history, and item information. The storage 238 may also include a queue or database 256 where the queue 256 may be used to store may be used to store buyer or seller information including general information, transaction ratings, sales history, and item information. In an embodiment the web-server 254 and the application module 252 may be separate elements. In an embodiment, the web-server 254 may generate content for buyer and seller browser applications.

The modem/transceiver 244 may couple, in a well-known manner, the device 230 to the network 16 to enable communication with the seller system 40 and buyer system 60, and VCP 52. In an embodiment, the modem/transceiver 244 may be a wireless modem or other communication device that may enable communication with the seller system 40 and buyer system 60. The CPU 232 via the web-server 254 may direct communication between modem 244 and the seller system 40 and buyer system 60.

The ROM 236 may store program instructions to be executed by the CPU 232, web-server 254, or application module 252. The RAM 234 may be used to store temporary program information, queues, databases, and overhead information. The storage device 238 may comprise any convenient form of data storage and may be used to store temporary program information, queues, databases, and overhead information.

Any of the components previously described can be implemented in a number of ways, including embodiments in software. Any of the components previously described can be implemented in a number of ways, including embodiments in software. Thus, the CPU 232, web-server 254, application module 252, modem/transceiver 2444, antenna 246, storage 238, RAM 234, ROM 236, queue 248, queue 256, CPU 262, application module 292, transceiver ASIC 274, antenna 284, microphone 288, speaker 282, ROM 266, RAM 264, queue 278, user input 272, display 268, publication system 50, seller system 40, and buyer system 60 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An system module, including:
a server to enable a first user to specify information about an item offered for one of purchase and bid and to display to a second user information about the item and an indication of a repeat transaction rating for the first user based on transactions conducted by the server for the first user.

2. The system of claim 1, wherein the server enables other users to rate transactions conducted with the first user and the repeat transaction rating for the first user is based on rated transactions conducted by the server for the first user.

3. The system of claim 1, wherein the server enables other users to rate transactions conducted with the first user as one of at least positive and negative and the repeat transaction rating for the first user is based on positively rated transactions conducted by the server for the first user.

4. The system of claim 1, wherein the server enables other users to rate transactions conducted with the first user as one of at least positive and negative and the repeat transaction rating for the first user is based on non-negatively rated transactions conducted by the server for the first user.

5. The system of claim 2, wherein the other users have transaction ratings and the repeat transaction rating for the first user is based on rated transactions conducted by the server for the first user and the other users transaction ratings.

6. The system of claim 3, wherein the other users have transaction ratings and the repeat transaction rating for the first user is based on positively rated transactions conducted by the server for the first user and the other users transaction ratings.

7. The system of claim 1, wherein each transaction has a value and the repeat transaction rating for the first user is based on the transaction value of transactions conducted by the server for the first user.

8. The system of claim 7, wherein the repeat transaction rating for the first user is based on the transaction value of positively rated transactions conducted by the server for the first user.

9. The system of claim 1, wherein each transaction is associated with a category of a plurality of categories, the item is associated with a category of the plurality of categories, and the repeat transaction rating for the first user is based on transactions conducted by the server for the first user associated with item's category.

10. The system of claim 9, wherein the server enables other users to rate transactions conducted with the first user as one of at least positive and negative and the repeat transaction rating for the first user is based on positively rated transactions conducted by the server for the first user associated with item's category.

11. A method, including:
enabling a first user to specify information at a server about an item offered for one of purchase and bid,
calculating a repeat transaction rating for the first user based on transactions conducted by the server for the first user, and
displaying to a second user information about the item and an indication of the calculated repeat transaction rating.

12. The method of claim 11, wherein the other users have transaction ratings and further including:
enabling other users to rate transactions conducted with the first user; and
calculating the repeat transaction rating for the first user based on rated transactions conducted by the server for the first user.

13. The method of claim 11, further including:
enabling the other users to rate transactions conducted with the first user as one of at least positive and negative; and
calculating the repeat transaction rating for the first user based on positively rated transactions conducted by the server for the first user.

14. The method of claim 11, further including:
enabling the other users to rate transactions conducted with the first user as one of at least positive and negative; and
calculating the repeat transaction rating for the first user based on non-negatively rated transactions conducted by the server for the first user.

15. The method of claim 12, wherein the other users have transaction ratings and further including calculating the repeat transaction rating for the first user based on rated transactions conducted by the server for the first user and the other users transaction ratings.

16. The method of claim 15, further including:
enabling the other users to rate transactions conducted with the first user as one of at least positive and negative; and
calculating the repeat transaction rating for the first user based on positively rated transactions conducted by the server for the first user and the other users transaction ratings.

17. The method of claim 11, wherein each transaction has a value and further including calculating the repeat transaction rating for the first user based on the transaction value of transactions conducted by the server for the first user.

18. The method of claim 17, further including:
enabling users to rate transactions conducted with other users as one of at least positive and negative and
calculating the repeat transaction rating for the first user based on transactions conducted by the server for the first user and another user that the other user rated positively and the transaction value.

19. The method of claim 11, wherein each transaction is associated with a category of a plurality of categories and the item is associated with a category of the plurality of categories and further including calculating the repeat transaction rating for the first user based on transactions conducted by the server for the first user associated with item's category.

20. An article including a machine-accessible medium having associated information, wherein the information, when accessed, results in a server performing the acts of:
enabling a first user to specify information at a server about an item offered for one of purchase and bid;
calculating a repeat transaction rating for the first user based on transactions conducted by the server for the first user; and
displaying to a second user information about the item and an indication of the calculated repeat transaction rating.

21. The article of claim 20, wherein the information, when accessed, results in the server further performing the acts of:
enabling other users to rate transactions conducted with the first user; and
calculating the repeat transaction rating for the first user based on rated transactions conducted by the server for the first user.

22. The article of claim 20, wherein the information, when accessed, results in the server further performing the acts of:
enabling the other users to rate transactions conducted with the first user as one of at least positive and negative; and
calculating the repeat transaction rating for the first user based on positively rated transactions conducted by the server for the first user.

23. The article of claim 20, wherein the information, when accessed, results in the server further performing the acts of:
enabling the other users to rate transactions conducted with the first user as one of at least positive and negative; and
calculating the repeat transaction rating for the first user based on non-negatively rated transactions conducted by the server for the first user.

24. The article of claim 20, wherein the other users have transaction ratings and the information, when accessed, results in the server further performing the act of:
calculating the repeat transaction rating for the first user based on rated transactions conducted by the server for the first user and the other users transaction ratings.

25. The article of claim 24, wherein the information, when accessed, results in the server further performing the acts of:
enabling the other users to rate transactions conducted with the first user as one of at least positive and negative; and
calculating the repeat transaction rating for the first user based on positively rated transactions conducted by the server for the first user and the other users transaction ratings.
